(19) United States
(12) Patent Application Publication
(10) Pub. No.: US 2026/0131776 A1
(43) Pub. Date: May 14, 2026

(54) AUTOMATIC BRAKE HOLD FOR ELECTROMECHANICAL BRAKE

(71) Applicant: HL MANDO CORPORATION, Gyeonggi-do (KR)

(72) Inventor: Gyunghun SIM, Bay City, MI (US)

(21) Appl. No.: 18/945,504

(22) Filed: Nov. 12, 2024

(51) Int. Cl. B60T 13/74; B60T 8/58; F16D 65/18; F16D 121/24; F16D 127/06

(52) U.S. Cl. CPC B60T 13/746; B60T 8/58; F16D 65/18; B60T 2201/10; F16D 2121/24; F16D 2127/06

(57) ABSTRACT

A vehicle may comprise: an electro-mechanical brake system comprising an electric motor mechanically connected to a brake pad assembly for performing a service brake operation and a parking brake operation; and a controller configured to, if the service brake operation has been performed by the electric motor of the electro-mechanical brake system for more than a preset time while the vehicle is stopped, control the electro-mechanical brake system to perform the parking brake operation such that a brake is automatically held by the parking brake operation without actuation of the electric motor of the electro-mechanical brake system.

### BACKGROUND

Various embodiments of the present disclosure generally relate to an electro-mechanical brake (EMB) system and more particularly to automatic brake hold wherein application of a brake can be held automatically without actuation of an actuator of an electromechanical brake system using a parking brake operation of the electromechanical brake system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or ABS, and electric or brake-by-wire. For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brake.

Generally, the brake system may include a service brake assembly and a parking brake assembly. The parking brake assembly may be used to prevent movement of the vehicle when a vehicle is stopped or parked. The parking brake assembly may be a discrete assembly. Alternatively, the service brake assembly and the parking brake assembly may be integrated into a single brake system. The parking brake assembly may utilize one or more components of the service brake assembly. That is, the parking brake assembly may use the piston and the brake pads of the service brake assembly to create the brake apply. For example, the parking brake assembly may move the piston, which may move the brake pads into contact with the rotor to create and maintain a brake apply by clamping force applied to the rotor.

### SUMMARY

The features and advantages of the present disclosure will be more readily understood and apparent from the following detailed description, which should be read in conjunction with the accompanying drawings, and from the claims which are appended to the end of the detailed description.

According to some exemplary embodiments of the present disclosure, a vehicle may comprise: an electro-mechanical brake system comprising an electric motor mechanically connected to a brake pad assembly for performing a service brake operation and a parking brake operation; and a controller configured to, when the service brake operation has been performed by the electric motor of the electro-mechanical brake system for more than a preset time while the vehicle is stopped, control the electro-mechanical brake system to perform the parking brake operation such that a brake is automatically held by the parking brake operation without actuation of the electric motor of the electro-mechanical brake system.

The controller may be configured to, when the service brake operation has been performed by the electric motor of the electro-mechanical brake system for more than the preset time while the vehicle is stopped, control the electro-mechanical brake system to change an operation of the electro-mechanical brake system from the service brake operation to the parking brake operation.

The controller may be configured to, in response to a command of releasing the automatically held brake, control the electro-mechanical brake system to deactivate the parking brake operation of the electro-mechanical brake system so that the electric motor of the electro-mechanical brake system is able to perform the service brake operation.

The electro mechanical brake system may comprise a parking lock mechanism configured to selectively lock a component of the electro-mechanical brake system such than the brake pad assembly mechanically connected to the component of the electro-mechanical brake system maintains a brake clamping force against a rotor associated with a vehicle wheel without the actuation of the electric motor of the electro-mechanical brake system, and the controller may be configured to, when the service brake operation has been performed by the electric motor of the electro-mechanical brake system for more than the preset time while the vehicle is stopped, control the electro-mechanical brake system to automatically hold the brake by locking the component of the electro-mechanical brake system by the parking lock mechanism of the electro-mechanical brake system.

The controller may be configured to, in response to a command of releasing the automatically held brake, control the parking lock mechanism or the electric motor of the electro-mechanical brake system to release a locked status of the component of the electro-mechanical brake system so that the electric motor of the electromechanical brake system is able to perform the service brake operation.

The parking lock mechanism may comprise a movable strut and the component of the electro-mechanical brake system has notches, and the parking lock mechanism may be configured to selective lock the component of the electro-mechanical brake system by engaging the movable strut of the parking lock mechanism with one of the notches of the component of the electro-mechanical brake system.

The electro-mechanical brake system may comprise a parking lock mechanism configured to selectively lock a component of the electromechanical brake system such than the brake pad assembly mechanically connected to the component of the electromechanical brake system is unmovable to automatically hold the brake without the actuation of the electric motor of the electro-mechanical brake system, and the controller may be configured to generate a clamping force of the brake pad assembly caused by the actuation of the electric motor, lock the component of the electromechanical brake system by the parking lock mechanism, and de-actuating the electric motor after the component of the electromechanical brake system is locked by the parking lock mechanism so that the brake is automatically held.

The controller may be configured to, in response to a command of releasing the automatically held brake, control the parking lock mechanism or the electric motor to release a locked status of the component of the electro-mechanical brake system so that the electric motor of the electro-mechanical brake system is able to perform the service brake operation.

According to certain exemplary embodiments of the present disclosure, a vehicle may comprise: an electro-mechanical brake system comprising an electric motor mechanically connected to a brake pad assembly for performing a service brake operation and a parking brake operation; and a controller configured to, in response to a command of activating automatic brake hold for automatically holding the vehicle stopped while the service brake operation is being performed by the electric motor of the electro-mechanical brake system, control the electro-mechanical brake system to perform the parking brake operation so that a brake is automatically held by the parking brake operation without actuation of the electric motor of the electro-mechanical brake system.

The controller may be configured to, in response to the command of activating the automatic brake hold while the service brake operation is being performed by the electric motor of the electro-mechanical brake system, control the electro-mechanical brake system to change an operation of the electro-mechanical brake system from the service brake operation to the parking brake operation.

The controller may be configured to, in response to a command of deactivating the automatic brake hold, control the electro-mechanical brake system to deactivate the parking brake operation of the electro-mechanical brake system so that the electric motor of the electro-mechanical brake system is able to perform the service brake operation.

The electro-mechanical brake system may comprise a parking lock mechanism configured to selectively lock a component of the electro-mechanical brake system such than the brake pad assembly mechanically connected to the component of the electro-mechanical brake system maintains a brake clamping force against a rotor associated with a vehicle wheel without the actuation of the electric motor of the electro-mechanical brake system, and the controller may be configured to, in response to the command of activating the automatic brake hold while the service brake operation is being performed by the electric motor of the electro-mechanical brake system, control the electro-mechanical brake system to automatically hold the brake by locking the component of the electro-mechanical brake system by the parking lock mechanism of the electro-mechanical brake system.

The controller may be configured to, in response to a command of deactivating the automatic brake hold, control the parking lock mechanism or the electric motor of the electro-mechanical brake system to release a locked status of the component of the electro-mechanical brake system so that the electric motor of the electromechanical brake system is able to perform the service brake operation.

The parking lock mechanism may comprise a movable strut and the component of the electro-mechanical brake system has notches, and the parking lock mechanism may be configured to selectively lock the component of the electro-mechanical brake system by engaging the movable strut of the parking lock mechanism with one of the notches of the component of the electro mechanical brake system.

The electro-mechanical brake system may comprise a parking lock mechanism configured to selectively lock a component of the electromechanical brake system such than the brake pad assembly mechanically connected to the component of the electromechanical brake system is unmovable for performing the automatic brake hold without the actuation of the electric motor of the electro-mechanical brake system, and the controller may be configured to, in response to the command of activating the automatic brake hold while the service brake operation is being performed by the electric motor of the electro-mechanical brake system, generate a clamping force of the brake pad assembly caused by the actuation of the electric motor, lock the component of the electromechanical brake system by the parking lock mechanism, and de-actuating the electric motor after the component of the electromechanical brake system is locked by the parking lock mechanism so that a brake is automatically held.

The controller may be configured to, in response to a command of deactivating the automatic brake hold, control the parking lock mechanism or the electric motor to release a locked status of the component of the electro-mechanical brake system so that the electric motor of the electro-mechanical brake system is able to perform the service brake operation.

According to some exemplary embodiments of the present disclosure, a computerized method may comprise: monitoring whether a service brake operation has been performed by an electric motor of an electro-mechanical brake system for more than a preset time while a vehicle is stopped, wherein the electro-mechanical brake system comprises the electric motor mechanically connected to a brake pad assembly for performing the service brake operation and a parking brake operation; and when the service brake operation has been performed by the electric motor of the electro-mechanical brake system for more than a preset time while the vehicle is stopped, controlling the electro-mechanical brake system to perform the parking brake operation such that a brake is automatically held by the parking brake operation without actuation of the electric motor of the electro-mechanical brake system.

The controlling of the electro-mechanical brake system to perform the parking brake operation may comprise, when the service brake operation has been performed by the electric motor of the electro-mechanical brake system for more than the preset time while the vehicle is stopped, controlling the electro-mechanical brake system to change an operation of the electro-mechanical brake system from the service brake operation to the parking brake operation.

The computerized method may further comprise, in response to a command of releasing the automatically held brake, controlling the electro-mechanical brake system to deactivate the parking brake operation of the electro-mechanical brake system so that the electric motor of the electro-mechanical brake system is able to perform the service brake operation.

The controlling of the electro-mechanical brake system to perform the parking brake operation may comprise, when the service brake operation has been performed by the electric motor of the electro-mechanical brake system for more than the preset time while the vehicle is stopped, controlling the electro-mechanical brake system to automatically hold the brake by locking a component of the electro-mechanical brake system by a parking lock mechanism configured to selectively lock the component of the electro mechanical brake system such than the brake pad assembly mechanically connected to the component of the electro-mechanical brake system maintains a brake clamping force against a rotor associated with a vehicle wheel without the actuation of the electric motor of the electro-mechanical brake system.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a schematic cross-sectional view of an electro-mechanical brake system according to an embodiment of the present disclosure;

FIG. 2 is a schematic cross-sectional view of showing a parking lock mechanism according to an exemplary embodiment of the present disclosure;

FIG. 3 is a flowchart for illustrating a method for performing automatic brake hold for an electro-mechanical brake system according to an embodiment of the present disclosure;

FIG. 4 is a graph for showing operations of an electro-mechanical brake system according to an exemplary embodiment of the present disclosure; and

FIG. 5 is a graph for showing operations of an electro-mechanical brake system according to conventional art.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

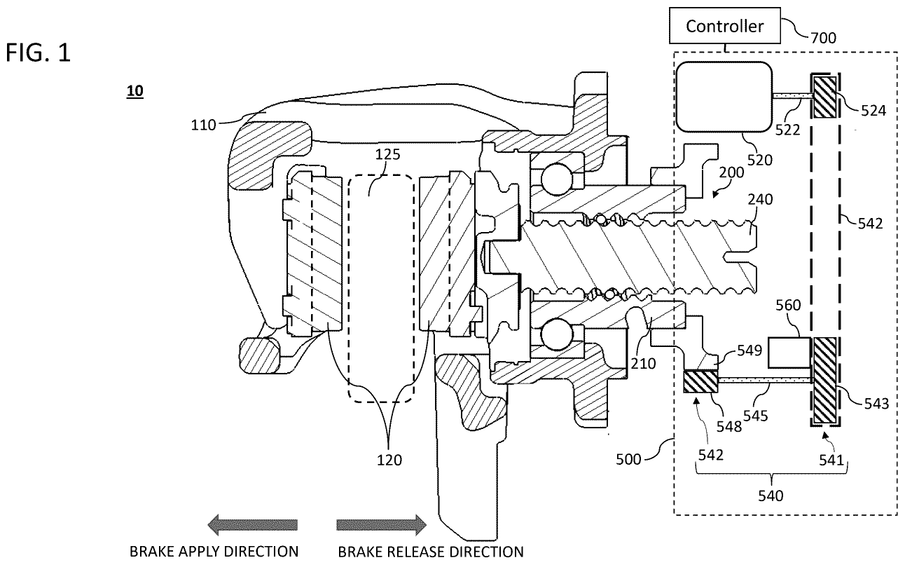

FIG. 1 is a schematic cross-sectional view of an electro-mechanical brake system according to an embodiment of the present disclosure.

Referring to FIG. 1, an electro-mechanical brake (EMB) system 10 may include a brake caliper 110 mounted in a floating manner by means of a brake carrier. When a vehicle is in motion, a brake rotor 125 may rotate with a wheel about an axle of the vehicle. Brake pad assemblies (or brake lining assemblies) 120 are provided in the brake caliper 110. The brake caliper 110 may include a bridge with fingers, and the fingers of the brake caliper 110 may be in contact with the brake pad assemblies 120. The brake pad assembly 120 is disposed with a small air clearance on a side of the brake rotor 125, such as a brake disc, in a release position so that no significant residual drag moment occurs.

The electro-mechanical brake system 10 may comprise a screw mechanism 200 (e.g. a ball screw mechanism or a nut-screw mechanism) configured to convert rotary motion generated by an actuator assembly 500 into linear motion in order to move the brake pad assembly 120 toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500, and is configured to be rotatable by actuation of the actuator assembly 500.

The actuator assembly 500 may comprises an electric motor 520. For example, the electric motor 520 may be directly engaged with the rotatably part 210 of the drive mechanism 200. Alternatively, the electric motor 520 may be indirectly connected to the rotatably part 210 through means for transferring rotary force generated by the electric motor 520, such as one or more gears, one or more belts, one or more pulleys, any other connecting means and combination thereof.

The actuator assembly 500 may have a multi-stage drive mechanism 540, although not required. The multi-stage drive mechanism 540 may be implemented as, for example, but not limited to, a dual-stage drive mechanism comprising a belt drive mechanism 541 and a gear drive mechanism 542 to multiply torque from the electric motor 520 to supply rotary force to the rotatable body 210 of the drive mechanism 200. The belt drive mechanism 541 multiplies the torque from the electric motor 520 by using a motor shaft 522, a drive pully 524 and a driven pulley 543 rotatably connected by a drive belt 542, and the torque multiplied by the belt drive mechanism 541 is delivered to the gear drive mechanism 546 through the intermediate shaft 545. The intermediate shaft 545 may connect the driven pulley 543 of the belt drive mechanism 541 to a first gear 548 of the gear drive mechanism 542 in order to deliver rotary torque, generated by the motor 520 and transmitted through the belt drive mechanism 541, to the gear drive mechanism 546. The first gear 548 is rotatably engaged with the second gear 549 to rotate the second gear 549 by the rotary torque transmitted through the intermediate shaft 545. The second gear 549 may be formed directly on a part of the circumferential surface of the rotatable body or nut 210 of the drive mechanism or screw-nut mechanism 200, or be mounted to the rotatable body 210 of the drive mechanism 200 to rotate the rotatable body or nut 210.

A controller 700 may be configured to control the actuator assembly 500 and a parking lock mechanism 560. The controller 700 controls the electric motor 520 to perform a service brake operation and a parking brake operation such as application or release of a service brake and a parking brake. The controller 700 may be, for example, but not limited to, a micro-controller unit (MCU), a circuit chip, a semiconductor circuit, and a circuit board having memory, one or more processors, and electric components. Further, the controller 700 may be configured to communicate with other controllers such as a central electronic control unit (ECU).

The mechanical connection between the electric motor 520 and the brake pad assemblies 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assemblies 120 can be used for the electro-mechanical brake system 10.

The electro-mechanical brake system 10 can perform automatic brake hold. When the automatic brake hold is activated, the electro-mechanical brake system 10 can maintain the application of the brake (e.g., clamping the brake pad assembly 120 against the brake rotor 125) automatically without involvement of a driver (e.g., pressing a brake pedal by the driver) after the vehicle is stopped. The terms “automatic” and “automatically” may mean without input or intervention from a driver or an operator of the vehicle. During the automatic brake hold, the vehicle keeps being stopped even if the driver does not press the brake pedal.

While the electro-mechanical brake system 10 is performing the automatic brake hold, the electric motor 520 may need to continuously generate force for maintaining the brake clamping force of the brake pad assembly 120 against the brake rotor 125 in order to remain the vehicle securely stopped.

And, even if the automatic brake hold is not activated, the service brake may be applied by the actuation of the electric motor 520 for a long time due to heavy traffic, a traffic signal, or long stop.

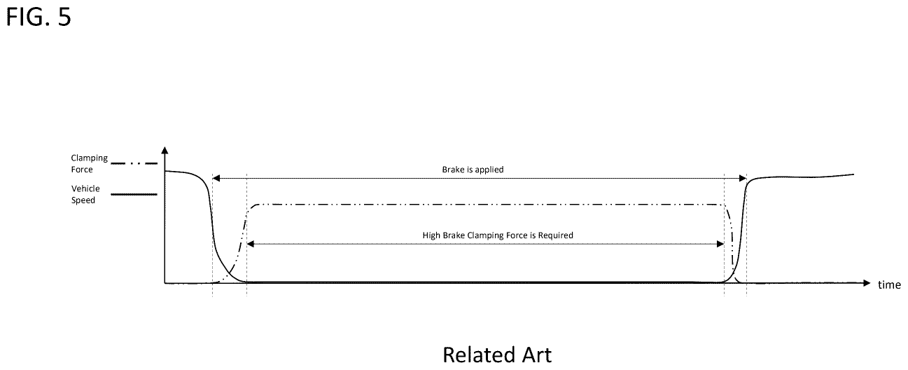

However, if the electric motor 520 continues to be actuated to generate the brake clamping force for more than certain amount of time as illustrated in FIG. 5, overheat may occur in the electric motor 520 and excessive power may be consumed by the electric motor 520 for performing the automatic brake hold or the service brake operation.

To solve these problems, according to some exemplary embodiments of the present disclosure, the electro-mechanical brake system 10 may use a parking brake operation for performing the automatic brake hold. As illustrated in FIG. 1, a service brake assembly and a parking brake assembly may be integrated together in the electro-mechanical brake system 10, and therefore the electro-mechanical brake system 10 may be configured to perform not only a service brake operation but also a parking brake operation. When or after the service brake operation has been performed by the electric motor 520 or the electric motor 520 has been actuated for more than a preset time period, the controller 700 can control the electro-mechanical brake system 10 to perform the parking brake operation. For example, the controller 700 changes a control mode of the electro-mechanical brake system 10 from a clamping force control mode for the service brake operation to a parking brake control mode for the parking brake operation. By the parking brake operation of the electro-mechanical brake system 10, the brake clamping force of the brake pad assembly 120 against the brake rotor 125 can be maintained even without actuation of the electric motor 520 by mechanically locking at least one of components of the electro-mechanical brake system 10 mechanically connected to the brake pad assembly 120 using the parking lock mechanism 560.

The parking lock mechanism 560 may be configured to lock the movement of a component of the electro-mechanical brake 10 such as a gear, a pulley, a shaft, a nut, and the like by being mechanically interlocked with at least one of components of the electro-mechanical brake system 10. For instance, a strut, a parking pawl or a locking gear included in the parking lock mechanism 560 may be engaged or interlocked with any component of the drive mechanism 200 or the actuator assembly 500, such as notches formed on a gear, a pulley, a gear, or a nut in order to lock the movement of the brake assembly 120. The details of exemplary embodiments of the parking lock mechanism 560 are described in U.S. application Ser. No. 17/579,552, filed on Jan. 19, 2022 and published as U.S. Patent Application Publication No. 2023/0228309 on Jul. 20, 2023, the entire teachings of which are incorporated by reference herein.

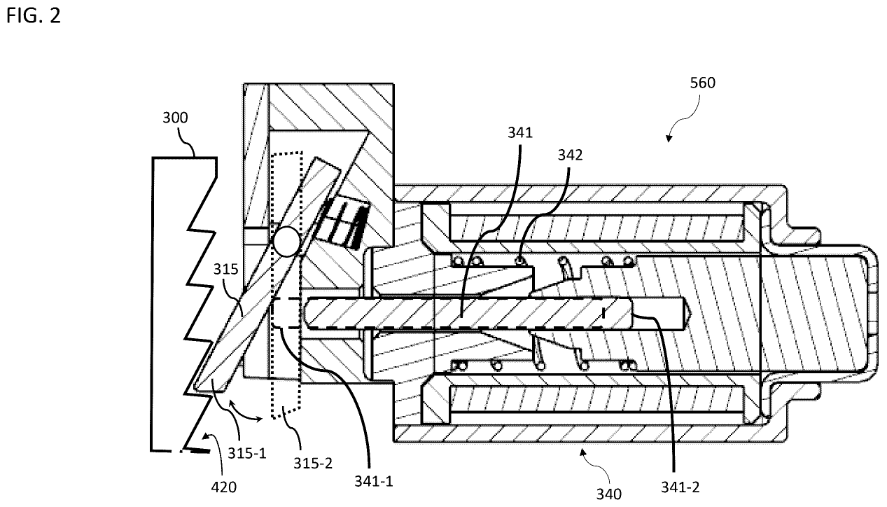

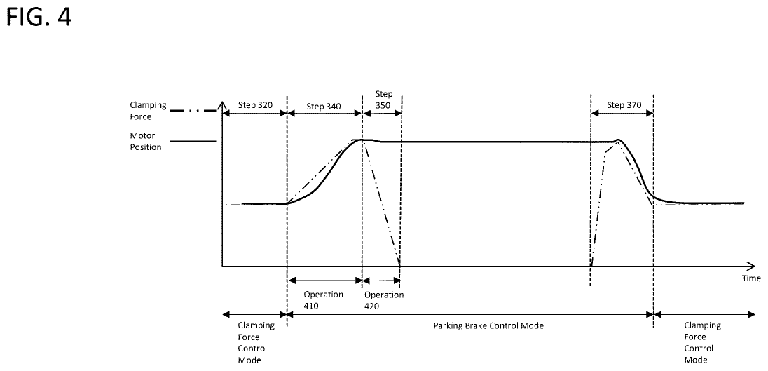

FIG. 2 is a schematic cross-sectional view of showing a parking lock mechanism according to an exemplary embodiment of the present disclosure. FIG. 4 is a graph for showing operations of an electro-mechanical brake system according to an exemplary embodiment of the present disclosure.

Referring to FIGS. 2 and 4, when the controller 700 controls the electro-mechanical brake system 10 to perform the parking brake operation, the electric motor 520 is actuated causing the brake caliper 110 to apply a brake clamping force that prevents movement of the vehicle through the actuator assembly 500 and the drive mechanism 200 (Operation 410).

If the brake is properly engaged by applying sufficient brake clamping force to the brake rotor 125, the motor torque generated by the electric motor 520 is decreased to allow a strut 315 to be engaged with one of notches 420 formed on one of components of the electro-mechanical brake system 10 (Operation 420). In FIG. 1, a component 300 of the electro-mechanical brake system 10 engaged with the strut 315 of the parking lock mechanism 560 is illustrated as the driven pulley 543, but not limited thereto. The component 300 of the electro-mechanical brake system 10 engaged with the strut 315 of the parking lock mechanism 560 can be any component of the electro-mechanical brake system 10 mechanically connected with the brake pad assembly 120. For example, the component 300 may be one of the drive pully 524, the intermediate shaft 545, the first gear 548, the second gear 549, or the rotatable body or nut 210.

At the same time or immediately after Operation 420, a parking lock actuator 340 is energized, causing a pin 341 to be moved from a retracted position 341-2 to an extended position 341-1 so that the pin 341 pushes the strut 315 toward the one component 300 of the electro-mechanical brake system 10 so as to pivotally rotate the strut 310 from a disengaged position 315-2 where the strut 310 is not engaged with any one of the notches 420 of the one component 300 of the electro-mechanical brake system 10 to an engaged position 315-2 where the strut 310 is engaged and interlocked with one of the notches 420 of the one component 300 of the electro-mechanical brake system 10.

After the strut 310 is interlocked with one of the notches 420 of the one component 300 of the electro-mechanical brake system 10 so that the one component 300 of the electro-mechanical brake system 10 is incapable of rotating in the brake release direction, the parking lock actuator 340 is de-energized and the motor torque generated by the electric motor 520 is released and then a pin return spring 342 urges the pin 341 to be returned from the actuated position (e.g. an extended position) to the unactuated position (e.g. a retracted position) in a direction moving the pin 341 away from the one component 300 of the electro-mechanical brake system 10 by the clastic restoration force of the pin return spring 342. Even after the pin 341 pushing the strut 310 is returned to the unactuated position (e.g. the retracted position), the strut 310 is in place and maintains the engagement with the one component 300 of the electro-mechanical brake system 10. In the parking brake state, the engagement/interlock of the strut 310 with the notch 420 of the one component 300 of the electro-mechanical brake system 10 can be maintained because when the electric motor 520 is de-energized the force against the brake clamping force in the direction of releasing the brake is generated between the brake pad assembly 120 and the brake rotor 125 but the strut 310 halts the rotation of the one component 300 of the electro-mechanical brake system 10 in the brake release direction. The parking lock mechanism 560 allows the power to be removed from the parking lock actuator 340 such as a solenoid and the electric motor 520 while maintaining the brake clamp force without reduction of the brake clamping force.

Accordingly, when or after the automatic brake hold is activated or the service brake operation has been performed by the electric motor 520 for more than a present time period, the controller 700 can control the electro-mechanical brake system 10 to perform the parking brake operation such that the parking lock mechanism 560 can mechanically lock the movement of the brake pad assembly 120 in order to maintain the vehicle in a stopped position without the actuation of the electric motor 520.

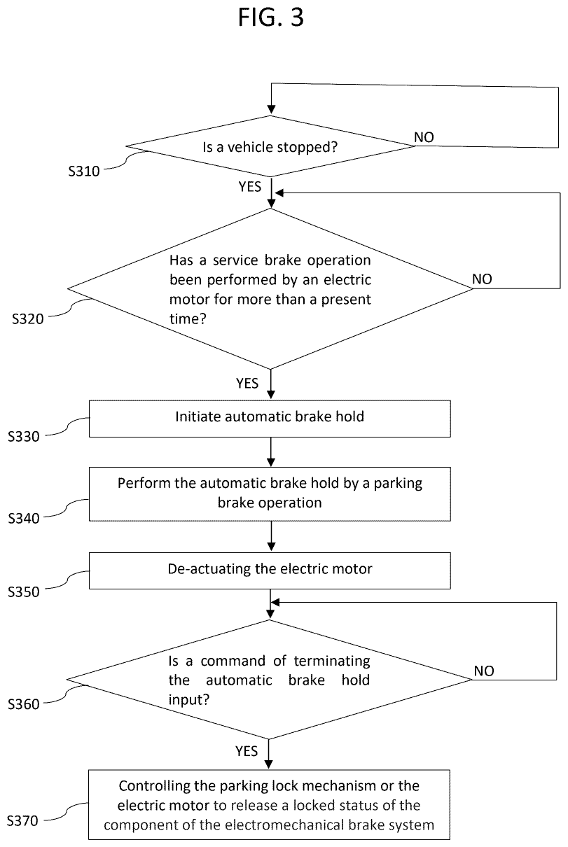

FIG. 3 is a flowchart for illustrating a method for performing automatic brake hold for an electro-mechanical brake system according to an embodiment of the present disclosure.

Referring to FIGS. 3 and 4, at Step S310, the controller 700 may check whether the vehicle is in a rolling condition (e.g., moving) or a stopped condition. For instance, the controller 500 monitors a speed of the vehicle calculated by a processor or sensed by one or more sensors to check whether the velocity of the vehicle has dropped to zero.

If the controller 500 determines that the vehicle is stopped at Step S310, the controller 500 monitors whether the service brake operation has been performed by the electric motor 520 of the electro-mechanical brake 10 for more than a preset time while the vehicle is stopped (Step S320). For instance, in Step S320, the controller 500 may check time duration of the driver's depressing the brake pedal after the velocity of the vehicle decreases to a preset value (for example, but not limited to, 0 mile/hour), a command transmitted to the electric motor 520, an elapsed time exceeding a preset time interval after the vehicle is stopped, or current or voltage supplied to the electric motor 520 of the electro-mechanical brake system 10 after the vehicle is stopped in order to monitor whether the service brake operation has been performed by the electric motor 520 of the electro-mechanical brake system 10 for more than the preset time.

If the controller 500 determines that time duration in which the service brake operation has been performed by the electric motor 520 of the electro-mechanical brake 10 after the vehicle is stopped elapse the preset time at Step S320, the controller 500 may initiate automatic brake hold (Step S330). The automatic brake hold may be a feature or function of maintaining the application of the brake (e.g., clamping the brake pad assembly 120 against the brake rotor 125) automatically without involvement of the driver (e.g., pressing a brake pedal by the driver) after the vehicle is stopped. The terms “automatic” and “automatically” may mean without input or intervention from a driver or an operator of the vehicle. During the automatic brake hold, the vehicle keeps being stopped even if the driver does not press the brake pedal.

When or after the automatic brake hold is initiated, the controller 500 controls the electro-mechanical brake system 10 such that the automatic brake hold is performed by the parking brake operation instead of the service brake operation in which the brake is applied by the actuation of the electric motor 520 of the electro-mechanical brake 10 (Step S340). For instance, during the automatic brake hold, the brake clamping force (e.g. force pressing the brake pad assembly 120 against the brake rotor 125) can be maintained by the parking brake operation of the electro-mechanical brake 10 without the actuation of the electric motor 520 of the electro-mechanical brake system 10.

When the automatic brake hold is being performed, the electro-mechanical brake system 10 can use the parking lock mechanism 560 in order to maintain the brake clamping force without the actuation of the electric motor 520 of the electro-mechanical brake system 10. For example, the parking lock mechanism 560 may comprise a strut, a parking pawl or a locking gear which is selectively engageable with one of notches formed on one of components (such as a gear, a pulley, a shaft, a nut, and the like) of the electro-mechanical brake system 10 mechanically connected to the brake pad assembly 120 to lock the movement of the one component of the electro-mechanical brake 10. Therefore, the parking lock mechanism 560 can mechanically prevent the movement of the brake pad assembly 120 in order to maintain the vehicle in a stopped position without force generated by the electric motor 520.

After one component of the electro-mechanical brake 10 is locked by the parking lock mechanism 560 so as to automatically maintain the brake clamping force without the actuation of the electric motor 520, the controller 700 de-actuates the electric motor 520 of the electro-mechanical brake 10 (Step S350). Even after the electric motor 520 of the electro-mechanical brake 10 is de-actuated, the brake clamping force can be maintained by the mechanical lock of the parking lock mechanism 560 with one of components of the electro-mechanical brake system 10.

At Step S360, the controller 700 checks whether a command of terminating the automatic brake hold is input. For example, the command of terminating the automatic brake hold may be generated in one or more preset conditions, for example, but not limited to, when the driver depresses an acceleration pedal or a brake pedal, when a switch or button for disenabling or turning off the automatic brake hold is manipulated by the driver, or when the controller 700 receives a command for moving the vehicle from other controller such as a central electric control unit (ECU).

If the controller 700 receives the command of terminating the automatic brake hold at Step S360, the controller 500 controls the parking lock mechanism 560 or the electric motor 520 to release a locked status of the component of the electromechanical brake system 10 so that the component of the electromechanical brake system 10 can be freely movable according to the actuation of the electric motor 520 and the electromechanical brake system 10 is able to perform the service brake operation.

According to certain exemplary embodiments of the present disclosure, when or after a service brake operation has been performed by an electric motor or the electric motor has been actuated for more than a preset time duration in an electro-mechanical brake, the electro-mechanical brake can use a parking brake operation to automatically hold a brake without actuation of the electric motor of the electro-mechanical brake. Therefore, overheat of the electric motor of the electro-mechanical brake may be prevented even in a state that a vehicle is stopped for a long time and power consumed for the operation of the brake of the vehicle may be reduced.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A vehicle comprising:
an electro-mechanical brake system comprising an electric motor mechanically connected to a brake pad assembly for performing a service brake operation and a parking brake operation; and
a controller configured to, when the service brake operation has been performed by the electric motor of the electro-mechanical brake system for more than a preset time while the vehicle is stopped, control the electro-mechanical brake system to perform the parking brake operation such that a brake is automatically held by the parking brake operation without actuation of the electric motor of the electro-mechanical brake system.

2. The vehicle of claim 1, wherein the controller is configured to, when the service brake operation has been performed by the electric motor of the electro-mechanical brake system for more than the preset time while the vehicle is stopped, control the electro-mechanical brake system to change an operation of the electro-mechanical brake system from the service brake operation to the parking brake operation.

3. The vehicle of claim 1, wherein the controller is configured to, in response to a command of releasing the automatically held brake, control the electro-mechanical brake system to deactivate the parking brake operation of the electro-mechanical brake system so that the electric motor of the electro-mechanical brake system is able to perform the service brake operation.

4. The vehicle of claim 1, wherein:
the electro-mechanical brake system comprises a parking lock mechanism configured to selectively lock a component of the electro-mechanical brake system such than the brake pad assembly mechanically connected to the component of the electro-mechanical brake system maintains a brake clamping force against a rotor associated with a vehicle wheel without the actuation of the electric motor of the electro-mechanical brake system, and
the controller is configured to, when the service brake operation has been performed by the electric motor of the electro-mechanical brake system for more than the preset time while the vehicle is stopped, control the electro-mechanical brake system to automatically hold the brake by locking the component of the electro-mechanical brake system by the parking lock mechanism of the electro-mechanical brake system.

5. The vehicle of claim 4, wherein the controller is configured to, in response to a command of releasing the automatically held brake, control the parking lock mechanism or the electric motor of the electro-mechanical brake system to release a locked status of the component of the electro-mechanical brake system so that the electric motor of the electromechanical brake system is able to perform the service brake operation.

6. The vehicle of claim 4, wherein;
the parking lock mechanism comprises a movable strut and the component of the electro-mechanical brake system has notches, and
the parking lock mechanism is configured to selective lock the component of the electro-mechanical brake system by engaging the movable strut of the parking lock mechanism with one of the notches of the component of the electro-mechanical brake system.

7. The vehicle of claim 1, wherein:
the electro-mechanical brake system comprises a parking lock mechanism configured to selectively lock a component of the electromechanical brake system such than the brake pad assembly mechanically connected to the component of the electromechanical brake system is unmovable to automatically hold the brake without the actuation of the electric motor of the electro-mechanical brake system, and
the controller is configured to generate a clamping force of the brake pad assembly caused by the actuation of the electric motor, lock the component of the electromechanical brake system by the parking lock mechanism, and de-actuating the electric motor after the component of the electromechanical brake system is locked by the parking lock mechanism so that the brake is automatically held.

8. The vehicle of claim 7, wherein the controller is configured to, in response to a command of releasing the automatically held brake, control the parking lock mechanism or the electric motor to release a locked status of the component of the electro-mechanical brake system so that the electric motor of the electro-mechanical brake system is able to perform the service brake operation.

9. A vehicle comprising:
an electro-mechanical brake system comprising an electric motor mechanically connected to a brake pad assembly for performing a service brake operation and a parking brake operation; and
a controller configured to, in response to a command of activating automatic brake hold for automatically holding the vehicle stopped while the service brake operation is being performed by the electric motor of the electro-mechanical brake system, control the electro-mechanical brake system to perform the parking brake operation so that a brake is automatically held by the parking brake operation without actuation of the electric motor of the electro-mechanical brake system.

10. The vehicle of claim 9, wherein the controller is configured to, in response to the command of activating the automatic brake hold while the service brake operation is being performed by the electric motor of the electro-mechanical brake system, control the electro-mechanical brake system to change an operation of the electro-mechanical brake system from the service brake operation to the parking brake operation.

11. The vehicle of claim 10, wherein the controller is configured to, in response to a command of deactivating the automatic brake hold, control the electro mechanical brake system to deactivate the parking brake operation of the electro-mechanical brake system so that the electric motor of the electro-mechanical brake system is able to perform the service brake operation.

12. The vehicle of claim 9, wherein:
the electro-mechanical brake system comprises a parking lock mechanism configured to selectively lock a component of the electro-mechanical brake system such than the brake pad assembly mechanically connected to the component of the electro-mechanical brake system maintains a brake clamping force against a rotor associated with a vehicle wheel without the actuation of the electric motor of the electro-mechanical brake system, and
the controller is configured to, in response to the command of activating the automatic brake hold while the service brake operation is being performed by the electric motor of the electro-mechanical brake system, control the electro-mechanical brake system to automatically hold the brake by locking the component of the electro-mechanical brake system by the parking lock mechanism of the electro mechanical brake system.

13. The vehicle of claim 12, wherein the controller is configured to, in response to a command of deactivating the automatic brake hold, control the parking lock mechanism or the electric motor of the electro-mechanical brake system to release a locked status of the component of the electro-mechanical brake system so that the electric motor of the electromechanical brake system is able to perform the service brake operation.

14. The vehicle of claim 12, wherein:
the parking lock mechanism comprises a movable strut and the component of the electro-mechanical brake system has notches, and
the parking lock mechanism is configured to selectively lock the component of the electro-mechanical brake system by engaging the movable strut of the parking lock mechanism with one of the notches of the component of the electro-mechanical brake system.

15. The vehicle of claim 9, wherein:
the electro mechanical brake system comprises a parking lock mechanism configured to selectively lock a component of the electromechanical brake system such than the brake pad assembly mechanically connected to the component of the electromechanical brake system is unmovable for performing the automatic brake hold without the actuation of the electric motor of the electro-mechanical brake system, and
the controller is configured to, in response to the command of activating the automatic brake hold while the service brake operation is being performed by the electric motor of the electro-mechanical brake system, generate a clamping force of the brake pad assembly caused by the actuation of the electric motor, lock the component of the electromechanical brake system by the parking lock mechanism, and de-actuating the electric motor after the component of the electromechanical brake system is locked by the parking lock mechanism so that a brake is automatically held.

16. The vehicle of claim 15, wherein the controller is configured to, in response to a command of deactivating the automatic brake hold, control the parking lock mechanism or the electric motor to release a locked status of the component of the electro-mechanical brake system so that the electric motor of the electro-mechanical brake system is able to perform the service brake operation.

17. A computerized method comprising:
monitoring whether a service brake operation has been performed by an electric motor of an electro-mechanical brake system for more than a preset time while a vehicle is stopped, wherein the electro-mechanical brake system comprises the electric motor mechanically connected to a brake pad assembly for performing the service brake operation and a parking brake operation; and
when the service brake operation has been performed by the electric motor of the electro-mechanical brake system for more than a preset time while the vehicle is stopped, controlling the electro-mechanical brake system to perform the parking brake operation such that a brake is automatically held by the parking brake operation without actuation of the electric motor of the electro-mechanical brake system.

18. The computerized method of claim 17, wherein the controlling of the electro-mechanical brake system to perform the parking brake operation comprises, when the service brake operation has been performed by the electric motor of the electro-mechanical brake system for more than the preset time while the vehicle is stopped, controlling the electro-mechanical brake system to change an operation of the electro-mechanical brake system from the service brake operation to the parking brake operation.

19. The computerized method of claim 17, further comprising, in response to a command of releasing the automatically held brake, controlling the electro-mechanical brake system to deactivate the parking brake operation of the electro-mechanical brake system so that the electric motor of the electro-mechanical brake system is able to perform the service brake operation.

20. The computerized method of claim 17, wherein the controlling of the electro-mechanical brake system to perform the parking brake operation comprises, when the service brake operation has been performed by the electric motor of the electro-mechanical brake system for more than the preset time while the vehicle is stopped, controlling the electro-mechanical brake system to automatically hold the brake by locking a component of the electro-mechanical brake system by a parking lock mechanism configured to selectively lock the component of the electro-mechanical brake system such than the brake pad assembly mechanically connected to the component of the electro-mechanical brake system maintains a brake clamping force against a rotor associated with a vehicle wheel without the actuation of the electric motor of the electro-mechanical brake system.
